(19) United States
(12) Patent Application Publication
(10) Pub. No.: US 2017/0321658 A1
(43) Pub. Date: Nov. 9, 2017

(54) WIND POWER GENERATION SYSTEM USING AIRSHIP

(71) Applicant: Kwangwoo AN, Seoul (KR)

(72) Inventor: Kwangwoo AN, Seoul (KR)

(21) Appl. No.: 15/180,575

(22) Filed: Jun. 13, 2016

(30) Foreign Application Priority Data
May 9, 2016 (KR) 10-2016-0056602

(51) Int. Cl. F03D 9/25; F03D 5/00; B64B 1/02; H02J 50/30; F03D 9/32

(52) U.S. Cl. CPC F03D 9/255; H02J 50/30; F03D 9/32; B64B 1/02; F03D 5/00

(57) ABSTRACT

The present invention relates a wind power generation system using an airship, which can generate wind power using strong wind of a jet stream by using the airship, convert the wind power into a laser beam and transmit the laser beam to the ground so that power can be produced on the ground by converting the laser beam into electricity. The present invention provides efficiency and convenience in collecting power of the airship on the ground by implementing a wind power generation system using an airship to include: an airship for producing power through wind power generation while floating in the air and transmitting the produced power as a laser beam; and a ground receiving unit for receiving the laser beam transmitted. from the airship and converting the laser beam into electricity.

### CROSS-REFERENCE TO RELATED Application

This application claims priority under 35 U.S.C. §119 to Korean Patent Application No. 10-2016-0056602, filed on May 9, 2016, which is hereby incorporated by reference herein in its entirety as if fully set forth.

### BACKGROUND OF THE INVENTION

### Field of the Invention

The present invention relates to a wind power generation system using an airship, and particularly, to a wind power generation system using an airship, which can generate wind power using strong wind of a jet stream in the upper troposphere, convert the wind power into a laser beam and transmit the laser beam to the ground so that power can be produced on the ground by converting the laser beam into electricity.

### Background of the Related Art

Wind power generation uses wind at the ground level. However, since the wind at the ground level is not strong and does not blow at all times, there is a limit in increasing the output power, and thus efficiency of generating the power is lowered, and the time capable of generating the power throughout the year is limited. Particularly, there are environmental problems, such as destroy of forests, noises and the like, in transportation and installation of wind power generators.

Meanwhile, at a predetermined altitude from the ground (in the upper troposphere), strong westerly wind blows at all times in a predetermined direction owing to the effect of the earth's rotation. This is called as a jet stream.

Since a strong wind blows near the upper troposphere at all times as described above, there are abundant wind power resources.

A common operating principle of the troposphere wind power generators is based on continuously flying an aerodynamic body which can convert wind energy into mechanical energy at a high altitude and, thereafter, convert this mechanical energy into electrical energy that can be generally used for civil and industrial purposes.

Although there is provided an “airship-type generator”, an “aerial wind power generation system using a tube floating body” or the like as a wind power generator formed to be attached to an airship, cost factors are increased in the development process itself due to the problems as described above. In addition, since several generators are installed in the airship, the weight of the airship increases, and thus volume of the airship should be relatively increased in order to enhance buoyance, and, therefore, the cost factors are further increased.

Prior technical documents related to the wind power generator using an airship are as described below.

Korean Patent Registration No. 10-0933514 (Wind power generation system using airborne airship)

Korean Laid-opened Patent No. 10-2011-0026314 (Wind power generation system mounted on airship)

Korean Laid-opened Patent No. 10-2014-0111414 (Airship operating system and method of maintaining position of airship using the same)

### SUMMARY OF THE INVENTION

The prior art as described above is a method of transmitting electrical energy obtained in an airship through wind power generation to the ground using a power line connected to the ground or transmitting the produced power to a ground system after landing the airship on the ground and flying the airship into the air again, it is disadvantageous in that transfer of the produced power is complicated and efficiency of the transmission is lowered.

Particularly, it is disadvantageous in that the method of transmitting power by connecting a power line between the airship and the ground system also generates complication according to installation of the power line.

Therefore, the present invention has been made in view of the above problems, and it is an object of the present invention to provide a wind power generation system using an airship, which can generate wind power using strong wind of a jet stream, convert the wind power into a laser beam and transmit the laser beam to the ground so that power can be produced on the ground by converting the laser beam into electricity.

Another object of the present invention is to provide a wind power generation system using an airship, which can stably transmit the produced power to the ground even in a situation difficult to directly emit a laser beam to the ground from the airship producing the power through wind power generation, since the power produced by the airship in the air is received and emitted to the ground as a laser beam by way of a relay airship.

To accomplish the above objects, according to one aspect of the present invention, there is provided a wind power generation system using an airship, the system including: the airship for producing power through wind power generation, converting the produced power into a laser beam and transmitting the laser beam to the ground while staying in an upper troposphere where a jet stream is generated; and a ground receiving unit for receiving the laser beam transmitted from the airship and converting the laser beam into electricity.

To accomplish the above objects, according to another aspect of the present invention, there is provided a wind power generation system using an airship, the system including: the airship for producing power through wind power generation, converting the produced power into a laser beam and transmitting the laser beam while staying in an upper troposphere where a jet stream is generated; a relay airship for receiving and converting the laser beam transmitted from the airship into electricity, converting the electricity into a laser beam again, and transmitting the laser beam to the ground; and a ground receiving unit for converting the laser beam transmitted from the relay airship into electricity.

### BRIEF DESCRIPTION OF THE DRAWINGS

FIG. 1 is a configuration view showing a first embodiment of a wind power generation system using an airship according to the present invention.

FIG. 2 is a configuration view showing an embodiment of the airship of FIG. 1.

FIG. 3 is a configuration view showing an embodiment of the ground receiving unit of FIG. 1.

FIG. 4 is an exemplary view showing an airship installed in a jet stream in the present invention.

FIG. 5 is a configuration view showing a relay airship in a second embodiment of a wind power generation system using an airship according to the present invention.

FIG. 6 is a configuration view showing an embodiment of the relay airship of FIG. 5.

FIG. 7 is an exemplary view showing installation positions of airships and relay airships in the present invention.

### DETAILED DESCRIPTION OF THE PREFERRED EMBODIMENT

### Embodiment 1

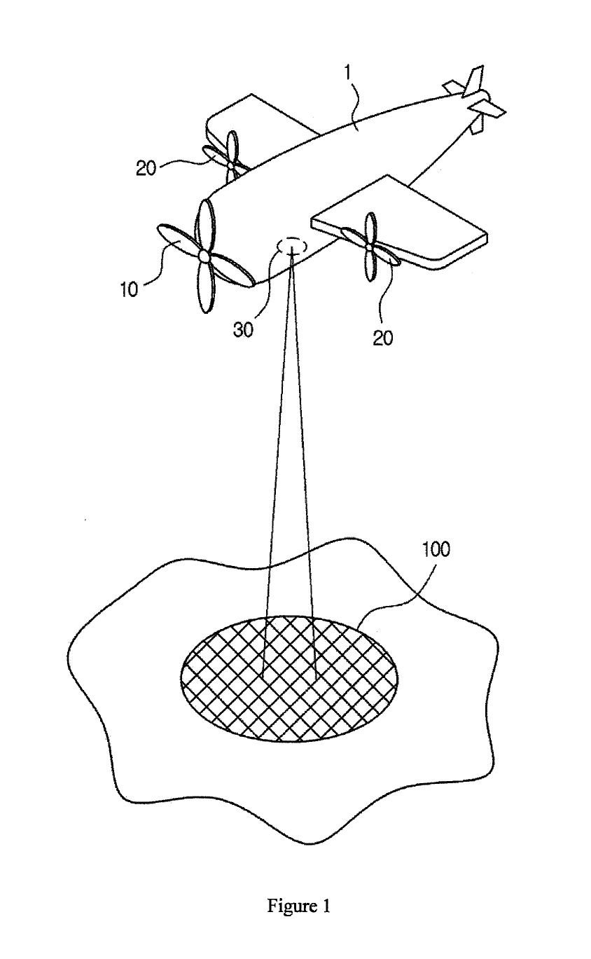

FIG. 1 is a configuration view showing a first embodiment of a wind power generation system using an airship according to a preferred embodiment of the present invention.

A first embodiment of the wind power generation system using an airship according to the present invention is configured of an airship 1 and a ground receiving unit 100. The airship 1 performs a function of producing power through wind power generation while floating in the air and transmitting the produced power to the ground, converts a power signal into a laser beam and transmits the laser beam to the ground, and it is preferable for the wind power generation system to produce power through wind power generation while staying in the upper troposphere where a jet stream is generated.

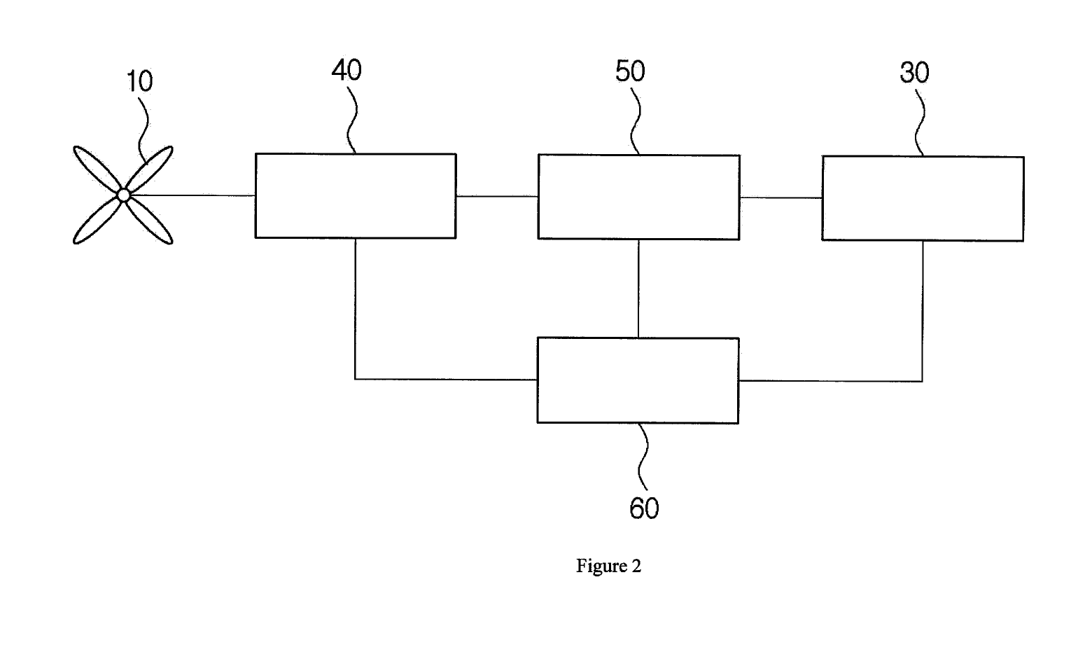

As shown in FIG. 2, the airship 1 includes a turbine 10 rotating by the jet stream, a power generation unit 40 for producing power by converting mechanical energy generated by the rotational force of the turbine 10 into electrical energy, a laser conversion unit 50 for converting the power produced by the power generation unit 40 into a laser beam, and a laser emission unit 30 for transmitting the laser beam converted by the laser conversion unit 50 to the ground.

The airship 1 preferably includes a cooling device 60 for detecting temperature inside the airship 1 and, if the detected temperature is higher than a set temperature, lowering the internal temperature of the airship 1 below the set temperature through a cooling function.

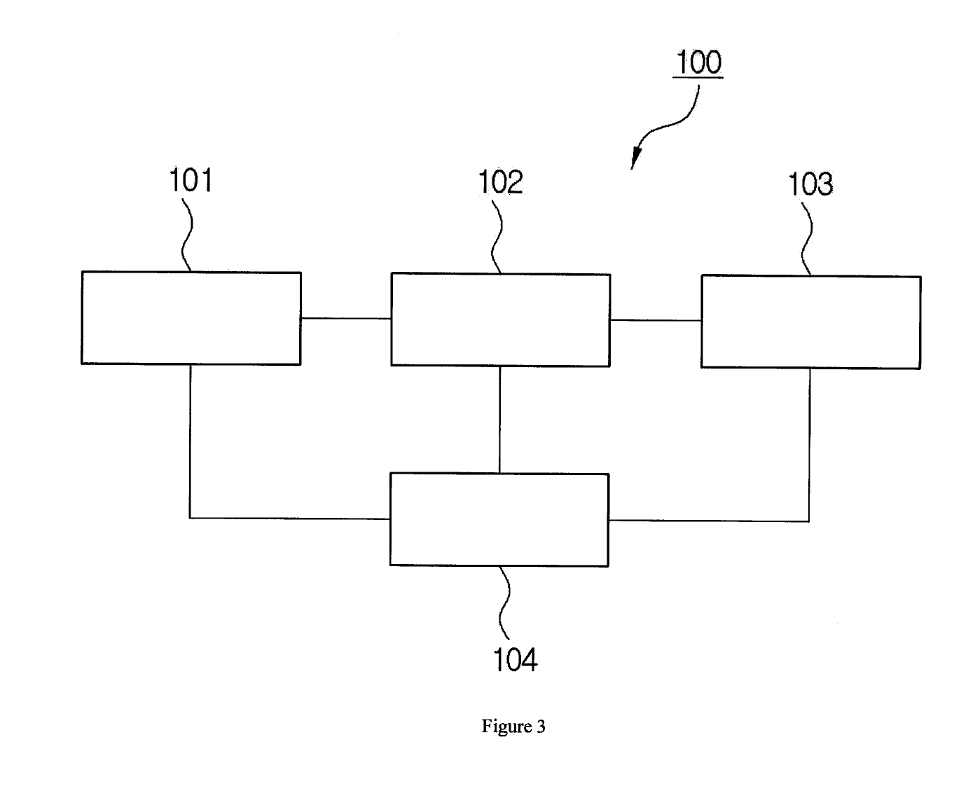

The ground receiving unit 100 performs a function of receiving the laser beam transmitted from the airship 1 and converting the laser beam into electricity and, as shown in FIG. 3, includes a laser receiving unit 101 for receiving the laser beam transmitted from the airship 1, a power conversion unit 102 for converting the laser beam received by the laser receiving unit into electrical energy, and a power storage unit 103 for storing the power converted by the power conversion unit 102, and the ground receiving unit 100 may include a cooling device 104 for detecting the internal temperature of the ground receiving unit 100 and, if the detected internal temperature is higher than a set temperature, maintaining the internal temperature to be proper by performing a cooling function.

A first embodiment of the wind power generation system using an airship according to the present invention configured like this will be described below in detail.

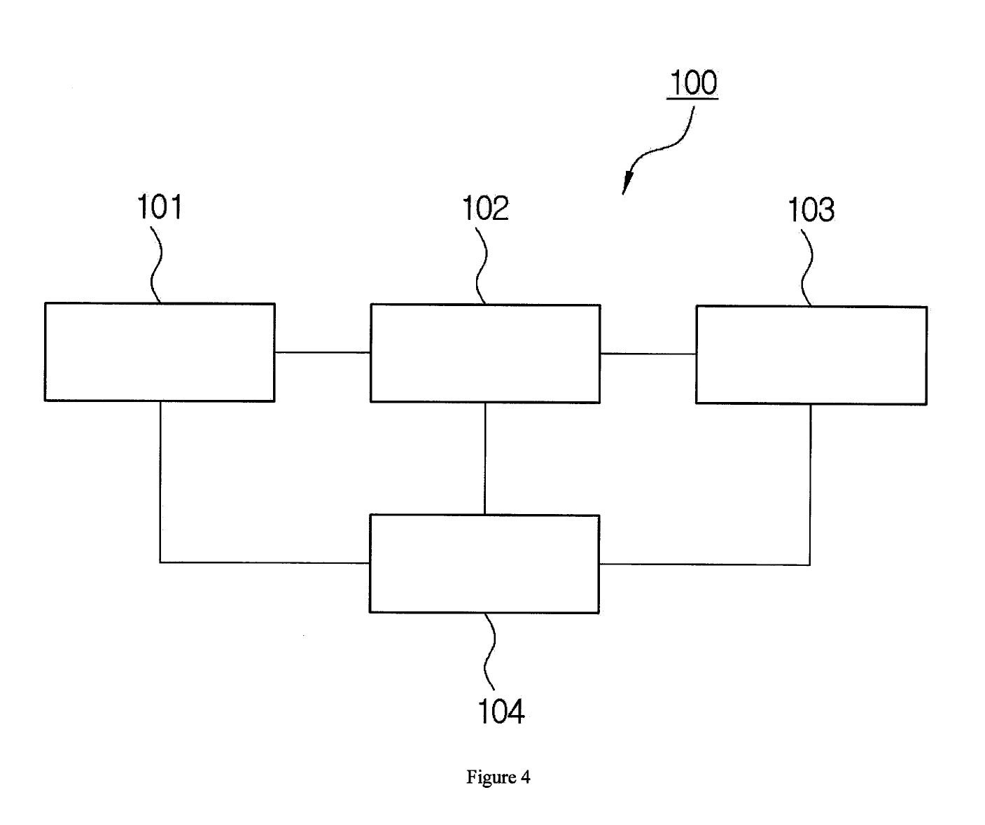

The airship 1 equipped with power generation equipment and laser emitting equipment is stationed in a jet stream to semi-permanently circulate in the direction of the jet stream. Here, since the jet stream is generally formed in the stratosphere, preferably, the airship 1 is also stationed in the stratosphere. In order to increase the amount of power production, it is preferable to station a plurality of airships 1 in the stratosphere to form a fleet as shown in FIG. 4.

The airship 1 generates power while cruising along the jet stream. Although it is not shown in the figure, it is considered that a wireless control device, a GPS and a control device are provided to adjust the height and to control the position of the airship 1. The airship 1 may descend on the ground using the wireless control device, the GPS and the control device.

Propellers 20 for controlling the direction of the airship 1 are installed on the wings of the airship 1, and the control device controls the direction control propellers 20 to adjust the airship 1 to be in line with the direction of the wind.

While being stationed at a proper position in the stratosphere, the airship 1 generates power as it cruises along the jet stream.

The turbine 10 rotates by the strong wind of the jet stream and generates a rotational force, and the power generation unit 40 converts mechanical energy generated by the rotational force of the turbine 40 into electrical energy. The electrical energy generated by the power generation unit 40 is converted into a laser beam by the laser conversion unit 50. Here, the laser beam is generated by amplifying light on a principle the same as that of amplifying a microwave by means of stimulated emission. The laser beam converted like this is transmitted to the ground through the laser emission unit 30. The laser beam transmitted like this is transmitted to the ground as a power signal.

Here, the airship 1 induces increase of temperature while generating power, converting the power into a laser beam and emitting the laser beam. Accordingly, the cooling device 60 is provided to prevent explosion of the airship 1 and abnormal operation of the devices internal to the airship 1 caused by the increase of temperature, and the internal temperature of the airship 1 is adjusted to a proper temperature at all times through the cooling function. That is, the cooling device 60 maintains the internal temperature of the airship 1 to be proper at all time in a method of detecting the internal temperature of the airship 1 using a temperature detection sensor, comparing the detected internal temperature with a previously set reference temperature and lowering, if the internal temperature is higher than the reference temperature, the internal temperature to be close to the reference temperature through the cooling function.

In the ground receiving unit 100 located on the ground, the laser receiving unit 101 receives the laser beam transmitted from the airship 1, and the power conversion unit 102 converts the received laser beam into electrical energy. Here, the laser receiving unit 101 may be implemented as a solar cell.

The power converted by the power conversion unit 102 is stored in the power storage unit 103 and distributed to the components where the power is needed. Profits can be made by selling the power to power distribution companies.

Preferably, the ground receiving unit 100 is also provided with the cooling device 104 to maintain the internal temperature of the ground receiving unit 100 to be proper.

Since the laser beam transmitted from the airship 1 may be harmful to a human body, the ground receiving unit 100 is preferably installed in a secluded place.

### Embodiment 2

The first embodiment as described above may pursue efficiency of wind power generation under the assumption that the airship 1 placed in the stratosphere may optimally transmit the laser beam to the ground at all times. Since the jet stream is a very strong wind, it may be difficult to accurately emit the laser beam from the airship cruising with the jet stream to the ground receiving unit.

Accordingly, in order to deal with such a case, in the present invention, a relay airship 200 separate from the airship 1 is placed outside the jet stream area to relay the power produced by the airship 1 to the ground.

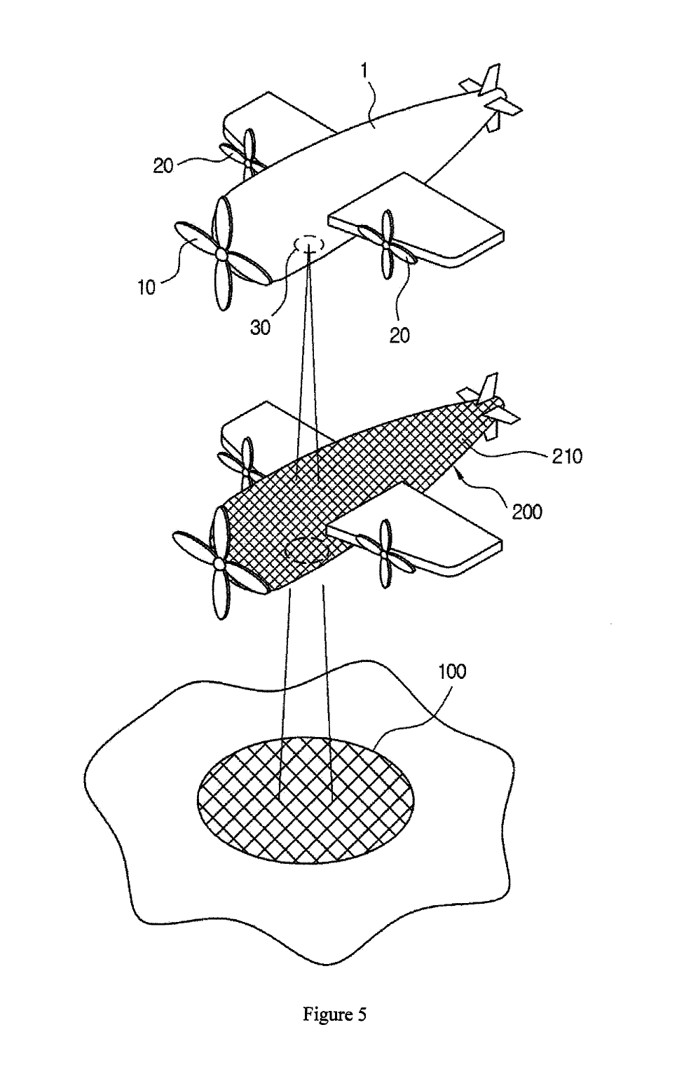

FIG. 5 is a view schematically showing the configuration of a relay airship 200 in a second embodiment of a wind power generation system using an airship according to the present invention.

The relay airship 200 is positioned between the airship 1 and the ground receiving unit 100 of the first embodiment of FIG. 1 to perform a function of receiving and converting the laser beam transmitted from the airship 1 into electricity, converting the electricity into a laser beam again, and transmitting the laser beam to the ground receiving unit 100.

Reference numeral 1 in FIG. 5 is an airship performing a function of producing power through wind power generation while floating in the air and transmitting the produced power to the ground as a laser beam, and reference numeral 100 is a ground receiving unit performing a function of converting the laser beam transmitted from the relay airship 200 into electricity.

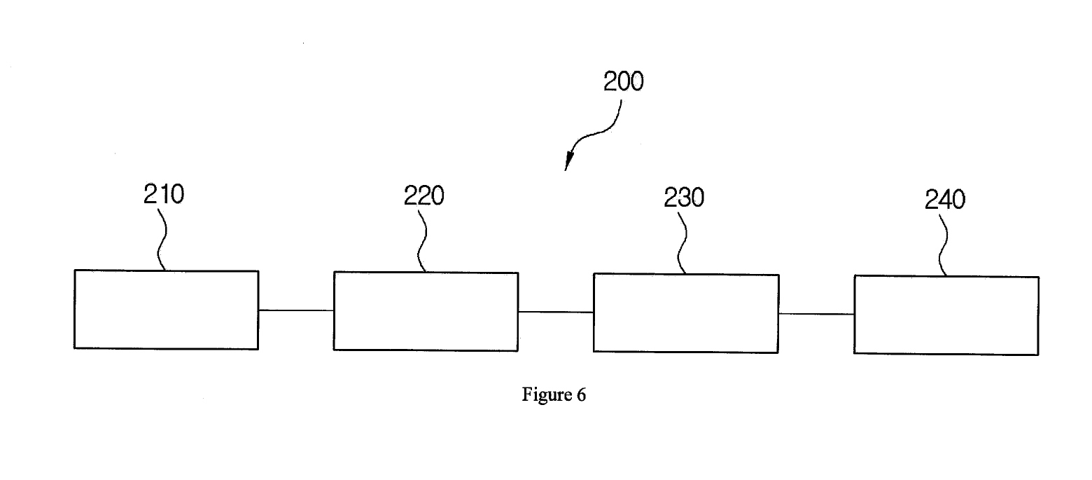

The relay airship 200 performs a function of receiving the laser beam transmitted from the airship 1 while staying at a fixed position out of the jet stream area and relaying the received power to the ground receiving unit 200 and, as shown in FIG. 6, includes a solar cell 210 for receiving the laser beam transmitted from the airship 1, a power conversion unit 220 for converting the laser beam received by the solar cell 210 into electricity, a laser conversion unit 230 for converting the electricity converted by the power conversion unit 220 into a laser beam, and a laser emission unit 240 for transmitting the laser beam converted by the laser conversion unit 230 to the ground, and its outer surface is preferably wrapped by the solar cell 210.

As shown in FIG. 3, the ground receiving unit 100 includes a laser receiving unit 101, a power conversion unit 102, a power storage unit 103 and a cooling device 104.

A second embodiment of the wind power generation system using an airship according to the present invention configured like this will be described below in detail.

The airship 1 is stationed in a jet stream to semi-permanently circulate in the direction of the jet stream. The electrical energy generated by the power generation unit 40 of the airship 1 is converted into a laser beam by the laser conversion unit 50. The converted laser beam is transmitted to the relay airship 200 through the laser emission unit 30. The transmitted laser beam is transmitted to the relay airship 200 as a power signal.

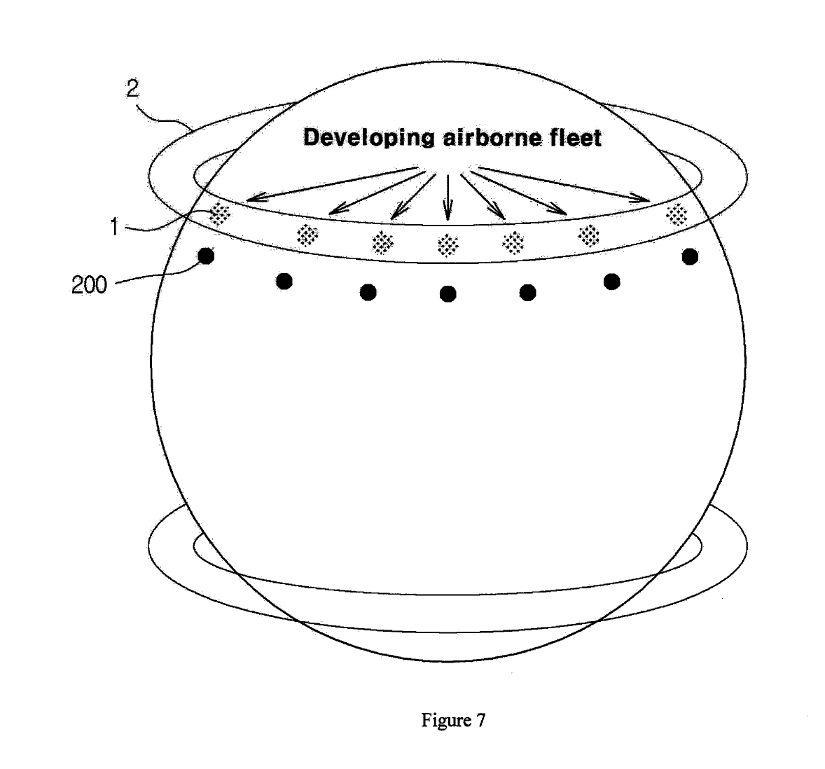

As shown in FIG. 7, the relay airship 200 is positioned in the stratosphere like the airship 1 and fixed at a specific position out of the jet stream area. In order to deal with a case in which it is difficult to directly emit a laser beam from the airship 1 to the ground receiving unit 100, the relay airship 200 receives the laser beam transmitted from the airship 1.

As shown in FIG. 6, the relay airship 200 receives the laser beam transmitted from the airship 1 using the solar cell 210, and the power conversion unit 220 converts the received laser beam into electrical energy. Then, the laser conversion unit 230 converts the generated electrical energy into a laser beam. The converted laser beam is transmitted to the ground through the laser emission unit 240.

Since the relay airship 200 also induces increase of temperature while receiving the laser beam, converting the laser beam and emitting the laser beam, it is provided with a cooling device and adjusts the internal temperature of the relay airship 200 to a proper temperature at all time through a cooling function.

In the ground receiving unit 100 located on the ground, the laser receiving unit 101 receives the laser beam transmitted from the relay airship 200, and the power conversion unit 102 converts the received laser beam into electrical energy. Here, the laser receiving unit 101 may be implemented as a solar cell.

According to the present invention, it has an advantage of providing efficiency and convenience in collecting power of an airship on the ground by generating wind power using a jet stream, converting the wind power into a laser beam, transmitting the laser beam to the ground, converting the laser beam into electricity and generating power.

In addition, according to the present invention, since the power produced by the airship in the air is received and emitted to the ground as a laser beam by way of a relay airship, it is advantageous in that the produced power can be stably transmitted to the ground even in a situation difficult to directly emit the laser beam to the ground from the airship producing the power through wind power generation.

What is claimed is:

1. A wind power generation system using an airship, the system comprising:
the airship for producing power through wind power generation, converting the produced power into a laser beam and transmitting the laser beam to a ground while staying in an upper troposphere where a jet stream is generated; and
a ground receiving unit for receiving the laser beam transmitted from the airship and converting the laser beam into electricity.

2. The system according to claim 1, wherein the airship includes:
a turbine rotating by the jet stream;
a power generation unit for producing the power by converting mechanical energy generated by a rotational force of the turbine into electrical energy;
a laser conversion unit for converting the power produced by the power generation unit into the laser beam; and
a laser emission unit for transmitting the laser beam converted by the laser conversion unit to the ground.

3. The system according to claim 1, wherein the airship includes a cooling device for detecting temperature inside the airship and, if the detected temperature is higher than a set temperature, lowering internal temperature of the airship below the set temperature through a cooling function.

4. The system according to claim 1, wherein the ground receiving unit includes:
a laser receiving unit for receiving a power signal transmitted from the airship;
a power conversion unit for converting the laser beam received by the laser receiving unit into electrical energy; and
a power storage unit for storing the power converted by the power conversion unit.

5. A wind power generation system using an airship, the system comprising:
the airship for producing power through wind power generation, converting the produced power into a laser beam and transmitting the laser beam while staying in an upper troposphere where a jet stream is generated;
a relay airship for receiving and converting the laser beam transmitted from the airship into electricity, converting the electricity into a laser beam again, and transmitting the laser beam to a ground; and
a ground receiving unit for converting the laser beam transmitted from the relay airship into electricity.

6. The system according to claim 5, wherein the airship includes:
a turbine rotating by the jet stream;
a power generation unit for producing the power by converting mechanical energy generated by a rotational force of the turbine into electrical energy;
a laser conversion unit for converting the power produced by the power generation unit into the laser beam; and
a laser emission unit for transmitting the laser beam converted by the laser conversion unit.

7. The system according to claim 5, wherein the airship includes a cooling device for detecting temperature inside the airship and, if the detected temperature is higher than a set temperature, lowering internal temperature of the airship below the set temperature through a cooling function.

8. The system according to claim 5, wherein the relay airship receives the laser beam transmitted from the airship while staying at a fixed position out of a jet stream area.

9. The system according to claim 5, wherein the relay airship includes:
a solar cell for receiving the laser beam transmitted from the airship;
a power conversion unit for converting the laser beam received by the solar cell into electricity;
a laser conversion unit for converting the electricity converted by the power conversion unit into a laser beam; and
a laser emission unit for transmitting the laser beam converted by the laser conversion unit to the ground.

10. The system according to claim 9, wherein an outer surface of the relay airship is wrapped by the solar cell.

11. The system according to claim 5, wherein the ground receiving unit includes:
a laser receiving unit for receiving the laser beam transmitted from the relay airship;
a power conversion unit for converting the laser beam received by the laser receiving unit into electrical energy; and
a power storage unit for storing the power converted by the power conversion unit.
